(19) United States
(12) Patent Application Publication
(10) Pub. No.: US 2023/0129988 A1
(43) Pub. Date: Apr. 27, 2023

(54) SILICA-FILLED RUBBER COMPOSITION AND METHOD FOR MAKING THE SAME

(71) Applicant: Bridgestone Americas Tire Operations, LLC, Nashville, TN (US)

(72) Inventor: Maryangel G. Dunlavy, Ravenna, OH (US)

(21) Appl. No.: 18/069,258

(22) Filed: Dec. 21, 2022

Related U.S. Application Data
(63) Continuation of application No. 14/353,723, filed on Apr. 23, 2014, now Pat. No. 11,535,687.
(60) Provisional application No. 61/550,474, filed on Oct. 24, 2011.

(51) Int. Cl. C08L 9/06; C08K 3/36; B60C 1/00; C08K 5/548; C08F 36/06; C08L 17/00; C08L 91/00; C08L 91/06

(52) U.S. Cl. CPC C08L 9/06; C08K 3/36; B60C 1/0016; C08K 5/548; B60C 1/00; C08F 36/06; C08L 17/00; C08L 91/00; C08L 91/06; C08K 3/04

(57) ABSTRACT

Disclosed is a method of preparing a rubber composition comprising the steps of (a) blending in at least one preparatory mixing step at least one natural or synthetic rubbery polymer, a silica filler, a silica coupling agent, and at least one vulcanization accelerator; and (b) subsequently blending therewith in a final mixing step a sulfur curative, wherein the average glass transition temperature of the polymer(s) is −55° C. or less.

### CROSS-REFERENCE TO RELATED APPLICATIONS

This application is a continuation of U.S. application Ser. No. 14/353,723, filed on Apr. 23, 2014 and entitled “SILICA-FILLED RUBBER COMPOSITION AND METHOD FOR MAKING THE SAME,” which is a U.S. national stage of International Application Number PCT/US2012/048125, filed on Jul. 25, 2012, and entitled “SILICA-FILLED RUBBER COMPOSITION AND METHOD FOR MAKING THE SAME,” which claims priority to and any other benefit of U.S. Provisional Patent Application Ser. No. 61/550,474, filed Oct. 24, 2011, and entitled “SILICA-FILLED RUBBER COMPOSITION AND METHOD FOR MAKING THE SAME,” the entire disclosure each of which is incorporated by reference herein.

### FIELD OF THE DISCLOSURE

This disclosure generally relates to a silica-filled rubber composition, and a method of making the same.

### BACKGROUND

Reinforcing fillers, such as carbon black and silica, are commonly introduced to confer certain favorable mechanical properties to cured rubber compositions. When used alone or in combination with carbon black, silica reinforcement may provide improved traction characteristics and rolling resistance when applied in tire components.

Rubber compositions containing silica are generally prepared in at least two mixing stages-at least one prepatory mixing step in which polymers, fillers, coupling agents, plasticizers, and the like are kneaded together, and a final mixing step in which vulcanization agents such as curatives and vulcanization accelerators are added. In practice, addition of vulcanization accelerators in any preparatory mixing stage is generally disfavored to avoid premature vulcanization.

### SUMMARY

Disclosed is a method of preparing a rubber composition comprising: a. blending in at least one preparatory mixing step (i) at least one natural or synthetic rubbery polymer, (ii) a silica filler, (iii) a silica coupling agent, and (iv) at least one vulcanization accelerator; and b. subsequently blending therewith in a final mixing step a sulfur curative, wherein the average glass transition temperature of the polymer(s) is −55° C. or less.

Also disclosed is a rubber composition produced by a method comprising: a. blending in at least one preparatory mixing step (i) at least one natural or synthetic rubbery polymer, (ii) a silica filler, (iii) a silica coupling agent, and (iv) at least one vulcanization accelerator; and b. subsequently blending therewith in a final mixing step a sulfur curative, wherein the average glass transition temperature of the polymer(s) is −55° C. or less.

Further disclosed is a tire tread comprising a rubber composition produced by a method comprising: a. blending in at least one preparatory mixing step (i) at least one natural or synthetic rubbery polymer, (ii) a silica filler, (iii) a silica coupling agent, and (iv) at least one vulcanization accelerator; and b. subsequently blending therewith in a final mixing step a sulfur curative, wherein the average glass transition temperature of the polymer(s) is −55° C. or less.

Other aspects of the present disclosure will be apparent to the ordinarily skilled artisan from the description that follows. To assist in understanding the description of various embodiments that follow, certain definitions are provided immediately below. These are intended to apply throughout unless the surrounding text explicitly indicates a contrary intention:

“polymer” means the polymerization product of one or more monomers and is inclusive of homo-, co-, ter-, tetra-polymers, etc.;

“copolymer” means a polymer that includes mer units derived from two reactants, typically monomers, and is inclusive of random, block, segmented, graft, gradient, etc., copolymers; and

“phr” means parts by weight of a referenced material per 100 parts by weight rubber, and is a recognized term by those having skill in the rubber compounding art.

The terms “rubber composition” and “rubber compound” may be used interchangeably.

All references incorporated herein by reference are incorporated in their entirety unless otherwise stated.

### DETAILED DESCRIPTION

Disclosed is a method of preparing a rubber composition comprising the steps of (a) blending in at least one preparatory mixing step at least one natural or synthetic rubbery polymer, a silica filler, a silica coupling agent, and at least one vulcanization accelerator; and (b) subsequently blending therewith in a final mixing step a sulfur curative, wherein the average glass transition temperature of the polymer(s) is −55° C. or less.

The natural or synthetic rubbery polymer can be any polymer suitable for use in a cap ply rubber composition. Examples of rubbery polymers that may be used in the compositions described herein include, but are not limited to, natural rubber, synthetic polyisoprene rubber, styrene-butadiene rubber (SBR), styrene-isoprene rubber, styrene-isoprene-butadiene rubber, butadiene-isoprene-styrene terpolymer, butadiene-isoprene rubber, polybutadiene, butyl rubber, neoprene, acrylonitrile-butadiene rubber (NBR), silicone rubber, the fluoroelastomers, ethylene acrylic rubber, ethylene-propylene rubber, ethylene-propylene terpolymer (EPDM), ethylene vinyl acetate copolymer, epichlorohydrin rubber, chlorinated polyethylene-propylene rubbers, chlorosulfonated polyethylene rubber, hydrogenated nitrile rubber, and terafluoroethylene-propylene rubber. A mixture of rubbery polymers may be used.

The rubber composition contains a silica filler. Examples of reinforcing silica fillers which can be used include wet silica (hydrated silicic acid), dry silica (anhydrous silicic acid), calcium silicate, and the like. Among these, precipitated amorphous wet-process, hydrated silicas are preferred. Silica can be employed in an amount of about 1 to about 100 phr, in an amount of about 5 to about 80 phr, or alternatively in an amount of about 30 to about 80 phr. The useful upper range is limited by the high viscosity imparted by fillers of this type. Some of the commercially available silicas which can be used include, but are not limited to, HiSil® 190, HiSil® 210, HiSil® 215, HiSil® 233, HiSil® 243, and the like, produced by PPG Industries (Pittsburgh, Pa.). A number of useful commercial grades of different silicas are also available from DeGussa Corporation (e.g., VN2, VN3), Rhone Poulenc (e.g., Zeosil® 1165MPO), and J. M. Huber Corporation.

In addition to the silica filler, carbon black may also be added to the rubber composition. The carbon black is typically added in at least one preparatory mixing step.

Carbon black, when present, may be used in an amount of about 1 to about 200 phr, in an amount of about 5 to about 100 phr, or alternatively in an amount of about 30 to about 80 phr. Suitable carbon blacks include commonly available, commercially-produced carbon blacks, but those having a surface area of at least 20 m²/g, or preferably, at least 35 m²/g up to 200 m²/g or higher are preferred. Among useful carbon blacks are furnace blacks, channel blacks, and lamp blacks. A mixture of two or more carbon blacks can be used. Exemplary carbon blacks include, but are not limited to, N-110, N-220, N-339, N-330, N-352, N-550, N-660, as designated by ASTM D-1765-82a.

If the rubber composition contains a blend of silica filler and carbon black, the ratio of silica to carbon black may range from about 0.1:1 to about 10:1, or from about 1:1 to about 10:1, or from about 5:1 to about 10:1.

The surface of the carbon black and/or silica may optionally be treated or modified to improve the affinity to particular types of polymers. Such surface treatments and modifications are well known to those skilled in the art.

Additional fillers may also be utilized, including but not limited to, mineral fillers, such as clay, talc, aluminum hydrate, aluminum hydroxide and mica. The foregoing additional fillers are optional and can be utilized in varying amounts from about 0.5 phr to about 40 phr.

The total amount of filler may be from about 1 to about 200 phr, alternatively from about 5 to about 100 phr, from about 10 phr to about 30 phr, from about 30 to about 80 phr, or from about 40 to about 70 phr.

A silica coupling agent is used to couple the silica to the rubbery polymer. Numerous coupling agents are known, including but not limited to organosulfide polysulfides and organoalkoxymercaptosilanes. Any organosilane polysulfide may be used. Suitable organosilane polysulfides include, but are not limited to, 3,3′-bis(trimethoxysilylpropyl)disulfide, 3,3′-bis(triethoxysilylpropyl)disulfide, 3,3′-bis(triethoxysilylpropyl)tetrasulfide, 3,3′-bis(triethoxysilylpropyl)octasulfide, 3,3′-bis(trimethoxysilylpropyl)tetrasulfide, 2,2′-bis(triethoxysilylethyl)tetrasulfide, 3,3′-bis(trimethoxysilylpropyl)trisulfide, 3,3′-bis(triethoxysilylpropyl)trisulfide, 3,3′-bis(tributoxysilylpropyl)disulfide, 3,3′-bis(trimethoxysilylpropyl)hexasulfide, 3,3′-bis(trimethoxysilylpropyl)octasulfide, 3,3′-bis(trioctoxysilylpropyl)tetrasulfide, 3,3′-bis(trihexoxysilylpropyl)disulfide, 3,3′-bis(tri-2″-ethylhexoxysilylpropyl)trisulfide, 3,3′-bis(triisooctoxysilylpropyl)tetrasulfide, 3,3′-bis(tri-t-butoxysilylpropyl)disulfide, 2,2′-bis(methoxydiethoxysilylethyl)tetrasulfide, 2,2′-bis(tripropoxysilylethyl)pentasulfide, 3,3′-bis(tricycloneoxysilylpropyl)tetrasulfide, 3,3′-bis(tricyclopentoxysilylpropyl)trisulfide, 2,2′-bis(tri-2″-methylcyclohexoxysilylethyl)tetrasulfide, bis(trimethoxysilylmethyl)tetrasulfide, 3-methoxyethoxypropoxysilyl 3′-diethoxybutoxy-silylpropyl tetrasulfide, 2,2′-bis(dimethylmethoxysilylethyl)disulfide, 2,2′-bis(dimethylsecbutoxysilylethyl) trisulfide, 3,3′-bis(methyl butylethoxysi lylpropyl)tetrasulfide, 3,3′-bis(dit-butylmethoxysilylpropyl) tetrasulfide, 2,2′-bis(phenylmethylmethoxysilylethyl)trisulfide, 3,3′-bis(diphenyl isopropoxysilylpropyl)tetrasulfide, 3,3′-bis(diphenylcyclohexoxysilylpropyl)disulfide, 3,3′-bis(dimethylethylmercaptosilylpropyl)tetrasulfide, 2,2′-bis(methyldimethoxysilylethyl)trisulfide, 2,2′-bis(methyl ethoxypropoxysilylethyl)tetrasulfide, 3,3′-bis(diethylmethoxysilylpropyl)tetrasulfide, 3,3′-bis(ethyldi-secbutoxysilylpropyl)disulfide, 3,3′-bis(propyldiethoxysilylpropyl) disulfide, 3,3′-bis(butyldimethoxysilylpropyl)trisulfide, 3,3′-bis(phenyldimethoxysilylpropyl)tetrasulfide, 3′-trimethoxysilylpropyl tetrasulfide, 4,4′-bis(trimethoxysilylbutyl)tetrasulfide, 6,6′-bis(triethoxysilylhexyl)tetrasulfide, 12,12′-bis(triisopropoxysilyl dodecyl)disulfide, 18,18′-bis(trimethoxysilyloctadecyl)tetrasulfide, 18,18′-bis(tripropoxysilyloctadecenyl)tetrasulfide, 4,4′-bis(trimethoxysilyl-buten-2-yl)tetrasulfide, 4,4′-bis(trimethoxysilylcyclohexylene)tetrasulfide, 5,5′-bis(dimethoxymethylsilylpentyl)trisulfide, 3,3′-bis(trimethoxysilyl-2-methylpropyl)tetrasulfide and 3,3′-bis(dimethoxyphenylsilyl-2-methylpropyl)disulfide.

Suitable organoalkoxymercaptosilanes include, but are not limited to, triethoxy mercaptopropyl silane, trimethoxy mercaptopropyl silane, methyl dimethoxy mercaptopropyl silane, methyl diethoxy mercaptopropyl silane, dimethyl methoxy mercaptopropyl silane, triethoxy mercaptoethyl silane, tripropoxy mercaptopropyl silane, ethoxy dimethoxy mercaptopropylsilane, ethoxy diisopropoxy mercaptopropylsilane, ethoxy didodecyloxy mercaptopropylsilane and ethoxy dihexadecyloxy mercaptopropylsilane. Such organoalkoxymercaptosilanes may be capped with a blocking group, i.e., the mercapto hydrogen atom is replaced with another group. A representative example of a capped organoalkoxymercaptosilane coupling agent is a liquid 3-octanoylthio-1-propyltriethoxysilane, commercially available as NXT™ Silane from Momentive Performance Materials Inc.

Mixtures of various organosilane polysulfide compounds and organoalkoxymercaptosilanes can be used.

The amount of coupling agent in the rubber composition is the amount needed to produce acceptable results, which is easily determined by one skilled in the art. The amount of coupling agent is typically based on the weight of the silica in the composition, and may be from about 0.1% to about 20% by weight of silica, from about 1% to about 15% by weight of silica, or alternatively from about 1% to about 10% by weight of silica.

Other ingredients that may be added to the rubber composition include, but are not limited to, oils, waxes, scorch inhibiting agents, tackifying resins, reinforcing resins, fatty acids such as stearic acid, and peptizers. These ingredients are known in the art, and may be added in appropriate amounts based on the desired physical and mechanical properties of the rubber composition.

A vulcanizing agent is added to the rubber composition. Suitable vulcanizing agents are known in the art, and may be added in appropriate amounts based on the desired physical, mechanical, and cure rate properties of the rubber composition. Examples of vulcanizing agents include sulfur and sulfur donating compounds. The amount of the vulcanizing agent used in the rubber composition may, in certain embodiments, be from about 0.1 to about 10 phr, or from about 1 to about 5 parts by weight per 100 phr.

At least one vulcanization accelerator is added to the rubber composition. The type of vulcanization accelerator is not particularly limited. Numerous accelerators are known in the art and include, but are not limited to, diphenyl guanidine (DPG), tetramethylthiuram disulfide (TMTD), 4,4′-dithiodimorpholine (DTDM), tetrabutylthiuram disulfide (TBTD), benzothiazyl disulfide (MBTS), 2-(morpholinothio) benzothiazole (MBS), N-tert-butyl-2-benzothiazole sulfonamide (TBBS), N-cyclohexyl-2-benzothiazole sulfonamide (CBS), and mixtures thereof. The total amount of vulcanization accelerator(s) used in the rubber composition may be from about 0.1 to about 10 phr or from about 1 to about 5 phr.

The rubber composition may be formed by mixing the ingredients together by methods known in the art, such as, for example, by kneading the ingredients together in a Banbury mixer.

As mentioned herein above, the rubber composition is formed by mixing the ingredients together in at least two mixing steps: at least one prepatory mixing step and a final mixing step. A prepatory mixing step is one in which no vulcanization agent, such as sulfur, is added. In the preparatory mixing step(s), the ingredients may be mixed to a temperature of about 140° C. to about 190° C., or to a temperatures of about 150° C. to about 180° C., or alternatively to a temperature of about 160° C. to about 175° C. If more than one prepatory mixing step is utilized, the temperatures of the prepatory mixing steps may be the same or different.

A final mixing step is one in which a vulcanizing agent, such as sulfur, is added. The final mixing step may further contain vulcanization accelerators. The final mixing step may be mixed to a temperature below the vulcanization temperature in order to avoid unwanted pre-cure of the rubber composition. Therefore, the temperature of the productive mixing stage should not exceed about 120° C. and is typically about 40° C. to about 120° C., or about 60° C. to about 110° C. and, especially, about 75° C. to about 100° C.

The composition is preferably allowed to cool to a temperature of 50° C. or lower between individual mixing steps.

One aspect of this disclosure is the fact that at least one vulcanization accelerator is added to to the rubber composition during a prepatory mixing step. Suitable vulcanization accelerators that may be added during a prepatory mixing step are not limited, and include the vulcanization accelerators mentioned herein above. In one embodiment, the vulcanization accelerator that is added in a prepatory mixing step is selected from the group consisting of diphenyl guanidine (DPG), tetrabutylthiuram disulfide (TBTD), benzothiazyl disulfide (MBTS), N-tert-butyl-2-benzothiazole sulfonamide (TBBS), N-cyclohexyl-2-benzothiazole sulfonamide (CBS), and mixtures thereof. In another embodiment, the vulcanization accelerator added during a prepatory mixing step is diphenyl guanidine (DPG).

The preparatory mixing step in which a vulcanization accelerator is added may be the same mixing step in which the polymer(s), silica, silica coupling agent, oil(s), and other ingredients are added. In one embodiment, the preparatory mixing step containing the vulcanization accelerator is a mixing step in which only a vulcanization accelereator is added, and is conducted after all polymer(s), silica, and silica coupling agent has been added. In another embodiment, all processing aids, stearic acid, and antidegredants such as N-(1,3-dimethylbutyl)-NT-phenyl-p-phenylene-diamine (6PPD), are added in a subsequent mixing stage to the preparatory mixing stage containing a vulcanization accelerator.

The amount of vulcanization accelerator added during the preparatory mixing step may vary, and may depend on the amount of silica filler and silica coupling agent. The amount of vulcanization accelerator added during a preparatory mixing stage may be from about 0.01 to about 5 phr, or from about 0.01 to about 3 phr, or from about 0.1 to about 1 phr. In one embodiment, at least one vulcanization accelerator is added during a prepatory mixing step, and at least one vulcanization accelerator is added during the final mixing stage. The vulcanization accelerator added during the final mixing stage may be the same as or different from the accelerator added during the preparatory mixing stage. In another embodiment, all of the vulcanization accelerators may be added during a preparatory mixing stage, meaning no vulcanization accelerator is added during the final mixing stage. The total amount of vulcanization accelerator(s) used in the rubber composition may be from about 0.1 to about 10 phr or from about 1 to about 5 phr.

Another aspect of this disclosure is that the average glass transition temperature (Tg) of the polymer(s) is −55° C. or less. The Tg is determined by a differential scanning calorimeter (DSC) at a rate of temperature increase of 20° C./min and calculated by the midpoint method, a method which is well known to persons skilled in the art. The average Tg of the polymers is a weighted average, thus accounting for the amount of each polymer in the rubber composition. For example, a rubber composition containing 70 phr of a polymer having a Tg of −20° C. and 30 phr of a polymer having a Tg of −60° C. has an average polymer Tg of −32° C. (((70 phr X −20° C.)+(30 phr X −60° C.))/100 phr). In one embodiment, the average Tg of the polymer(s) is −60° C. or less.

Without intending to be bound by theory, it is believed that the addition of a vulcanization accelerator in a preparatory mixing stage catalyzes the silanization reaction between the silica coupling agent and the rubbery polymer. It has unexpectedly been found that the affects of the improved silanization reaction are impacted by the average Tg of the polymer(s) in the rubber composition. For example, if the rubber composition is used as a tire tread composition, it has been found that when the average Tg of the polymer(s) in the rubber composition is −55° C. or less, the snow traction of the tread may be improved by the addition of a vulcanization accelerator in a preparatory mixing step.

The rubber composition formed according to the disclosure herein is particularly useful as a tire tread rubber composition. However, in certain embodiments, it may be used as another tire component, such as a sidewall, bead filler, undertread, or a coating for a carcass ply. Additionally, other rubber articles may be formed from the rubber composition of the disclosure, such as an air spring component.

The present disclosure will be described in more detail with reference to the following examples. The following examples are presented for purposes of illustration only and are not to be construed in a limiting sense.

### EXAMPLES

Eight rubber compositions were prepared from the ingredients shown in Table 1. All amounts shown are in phr. Samples A, B, C, and D were mixed in two mixing steps in a Banbury type mixer—a preparatory mixing step and a final mixing step. The ingredients in the preparatory mixing stage were mixed to a temperature of about 175° C. before being dropped from the mixer, while the ingredients in the final mixing step were mixed to a temperature of about 110° C. before being dropped from the mixer.

Samples A′, B′, C′, and D′ were mixed in three mixing stages—two preparatory mixing steps and a final mixing step. The ingredients in each preparatory mixing step were mixed to a temperature of about 175° C. before being dropped from the mixer, while the ingredients in the final mixing step were mixed to a temperature of about 110° C. before being dropped from the mixer.

TABLE 1

| | A | A′ | B | B′ | c | C′ | D | D′ |
|---|---|---|---|---|---|---|---|---|
| First Preparatory Mixing Step | | | | | | | | |
| SBR (−22° C. Tg) | 60 | 60 | 40 | 40 | 29.5 | 29.5 | 17.5 | 17.5 |
| SBR (−69° C. Tg) | 40 | 40 | 60 | 60 | 70.5 | 70.5 | 82.5 | 82.5 |
| Devulcanized Rubber | 5 | 5 | 5 | 5 | 5 | 5 | 5 | 5 |
| Carbon Black | 7 | 7 | 7 | 7 | 7 | 7 | 7 | 7 |
| Silica | 63 | 63 | 63 | 63 | 63 | 63 | 63 | 63 |
| 3,3′-bis(triethoxysilylpropyl)disulfide | 5.4 | 5.4 | 5.4 | 5.4 | 5.4 | 5.4 | 5.4 | 5.4 |
| Oil | 42.5 | 42.5 | 42.5 | 42.5 | 42.5 | 42.5 | 42.5 | 42.5 |
| Wax | 1.5 | 1.5 | 1.5 | 1.5 | 1.5 | 1.5 | 1.5 | 1.5 |
| Stearic Acid | 1 | 0 | 1 | 0 | 1 | 0 | 1 | 0 |
| N-(1,3 Dimethylbutyl)-N′-Phenyl-P- | 0.95 | 0 | 0.95 | 0 | 0.95 | 0 | 0.95 | 0 |
| Phenylene-Diamine | | | | | | | | |
| Second Preparatory Mixing Step | | | | | | | | |
| N,N′-Diphenylguanidine | 0 | 1 | 0 | 1 | 0 | 1 | 0 | 1 |
| Final Mixing Step | | | | | | | | |
| Sulfur | 1.6 | 1.6 | 1.6 | 1.6 | 1.6 | 1.6 | 1.6 | 1.6 |
| N,N′-Diphenylguanidine | 1 | 0.4 | 1 | 0.4 | 1 | 0.4 | 1 | 0.4 |
| N-Cyclohexyl-2- | 1.4 | 1.4 | 1.4 | 1.4 | 1.4 | 1.4 | 1.4 | 1.4 |
| 2,2′-Dithiobis(benzothiazole) | 1.4 | 1.4 | 1.4 | 1.4 | 1.4 | 1.4 | 1.4 | 1.4 |
| Stearic Acid | 0 | 1 | 0 | 1 | 0 | 1 | 0 | 1 |
| Zinc Oxide | 2.5 | 2.5 | 2.5 | 2.5 | 2.5 | 2.5 | 2.5 | 2.5 |
| N-(1,3 Dimethylbutyl)-N′-Phenyl-P- | 0 | 0.95 | 0 | 0.95 | 0 | 0.95 | 0 | 0.95 |
| Phenylene-Diamine | | | | | | | | |
| Polymerized 2,2,4-Trimethyl-1,2- | 0.22 | 0.22 | 0.22 | 0.22 | 0.22 | 0.22 | 0.22 | 0.22 |
| dihydroquinoline | | | | | | | | |

The rubber compositions had the properties shown in Table 2. Dynamic viscoelastic mechanical property determinations for E′ and tangent delta were made by temperature sweep tests conducted at a frequency of 52 Hz using 0.2% strain for temperatures from −50° C. to −6° C. and using 1.0% strain for temperatures from −5° C. to 60° C. The specimens used for dynamic viscoelastic testing were cured for 15 minutes at 170° C., and had the following dimensions: 40 mm long, 4.7 mm wide, and 2 mm thick.

TABLE 2

| | A | A′ | B | B′ | C | C′ | D | D′ |
|---|---|---|---|---|---|---|---|---|
| Average Tg of Polymers | −40.8 | −40.8 | −50.2 | −50.2 | −55.2 | −55.2 | −60.8 | −60.8 |
| E′@ −20° C. (MPa) | 223.8 | 180.0 | 120.9 | 81.8 | 94.5 | 48.6 | 67.7 | 36.7 |
| E′@ 0° C. (MPa) | 29.3 | 17.6 | 25.5 | 14.2 | 24.8 | 11.4 | 21.8 | 11.4 |
| Tangent Delta @ O° C. | 0.541 | 0.628 | 0.442 | 0.489 | 0.399 | 0.419 | 0.356 | 0.358 |
| E′@ 30° C. (MPa) | 13.1 | 7.3 | 13.2 | 7.1 | 13.7 | 6.3 | 12.8 | 7.0 |
| Tangent Delta @ 30° C. | 0.277 | 0.244 | 0.262 | 0.226 | 0.255 | 0.202 | 0.244 | 0.202 |
| E′@ 60° C. (MPa) | 9.2 | 5.3 | 9.5 | 5.4 | 10.1 | 4.9 | 9.6 | 5.5 |
| Tangent Delta @ 60° C. | 0.186 | 0.149 | 0.184 | 0.147 | 0.182 | 0.138 | 0.180 | 0.143 |

Table 3 shows the percent change of E′ @−20° C. for A′ vs. A, B′ vs. B, C′ vs. C, and D′ vs. D.

TABLE 3

| | A′ vs. A | B′ vs. B | C′ vs. C | D′ vs. D |
|---|---|---|---|---|
| % Change in E′@ −20° C. | −20 | −32 | −49 | −46 |

As can be seen from Tables 2 and 3, the addition of a vulcanization accelerator in a preparatory mixing step unexpectedly has a much larger affect on the E′ @ −20° C. when the rubber composition has an average polymer Tg of −55° C. or lower. If the rubber composition is used as a tire tread, the larger reduction in E′ @ −20° C. is indicative that the addition of a vulcanization accelerator in a preparatory mixing step to a rubber composition having an average polymer Tg of −55° C. or less will result in a greater improvement in snow traction.

The description has been provided with exemplary embodiments. Modifications and alterations may occur to others upon reading and understanding the preceding detailed description. It is intended that the disclosure and exemplary embodiments be construed as including all such modifications and alterations insofar as they come within the scope of the appended claims or the equivalents thereof.

What is claimed is:

1. A method of preparing a rubber composition comprising:
a. blending in at least one preparatory mixing step
(i) at least one natural or synthetic rubbery polymer selected from the group consisting of natural rubber, synthetic polyisoprene rubber, styrene-butadiene rubber (SBR), styrene-isoprene rubber, styrene-isoprene-butadiene rubber, butadiene-isoprene rubber, butadiene-isoprene-styrene terpolymer, polybutadiene rubber, neoprene, and mixtures thereof and wherein the at least one natural or synthetic rubbery polymer includes at least one styrene-butadiene rubber,
(ii) a silica filler and a carbon black filler,
(iii) a silica coupling agent selected from the group consisting of organosilane polysulfides, organoalkoxymercaptosilanes, capped organoalkoxymercaptosilanes; and mixtures thereof, and
(iv) at least one guanidine-based vulcanization accelerator in an amount of 1 to 10 phr,
wherein no preparatory mixing step adds elemental sulfur, a thiocarbamate-based compound, a benzothiazole-based compound, a thiuram sulfide-based compound, or 4,4-dithiodimorpholine (DTDM); and
b. subsequently blending therewith in a final mixing step a sulfur curative selected from elemental sulfur and sulfur donating compounds, wherein the average glass transition temperature of the polymer(s) is −55° C. or less.

2. The method of claim 1, wherein the at least one guanidine-based vulcanization accelerator is used in an amount of 1 to 3 phr.

3. The method of claim 1, wherein the silica coupling agent is an organosilane polysulfide selected from the group consisting of 3,3′-bis(trimethoxysilylpropyl)disulfide, 3,3′-bis(triethoxysilylpropyl)disulfide, 3,3′-bis(tributoxysilylpropyl)disulfide, 3,3′-bis(trihexoxysilylpropyl)disulfide, 3,3′-bis(tri-t-butoxysilylpropyl)disulfide, 3,3′-bis(dimethylmethoxysilylethyl)disulfide, 3,3′-bis(diphenylcyclohexoxysilylpropyl)disulfide, 3,3′-bis(ethyldi-secbutoxysilylpropyl)disulfide, 3,3′-bis(propyldiethoxysilylpropyl)disulfide, 12,12′-bis(triisopropyloxysilyldodecyl)disulfide, 3,3′-bis(dimethoxyphenylsilylpropyl)disulfide, and combinations thereof.

4. The method of claim 1, wherein the at least one natural or synthetic rubbery polymer further comprises polybutadiene rubber.

5. The method of claim 1, wherein the at lest one natural or synthetic rubbery polymer further comprises natural rubber.

6. The method of claim 1, wherein the silica coupling agent comprises 3,3′-bis(triethoxysilylpropyl)disulfide.

7. The method of claim 1, wherein the preparatory mixing step containing the at least one guanidine-based vulcanization accelerator is mixed to a temperature of 140° C. to 190° C.

8. The method of claim 1, wherein the at least one guanidine-based vulcanization accelerator is 1,3-diphenylguanidine.

9. The method of claim 1, wherein the silica filler is present in an amount of 30 to 100 phr.

10. The method of claim 9, wherein the carbon black filler is present in an amount of 1 to 30 phr.

11. The method of claim 1, wherein the at least one guanidine-based vulcanization accelerator is added in a separate preparatory mixing step after addition of (i), (ii), (iii), and (iv).

12. The method of claim 1, wherein the rubber composition includes one or more of: (v) processing aid(s), (vi) fatty acid(s), and (vii) antidegradant(s), and (v), (vi) and (vii) are added in a subsequent mixing stage to the preparatory mixing stage containing the at least one guanidine-based vulcanization accelerator.

13. A method of preparing a rubber composition comprising:
a. blending in at least one preparatory mixing step
(i) at least one natural or synthetic rubbery polymer selected from the group consisting of natural rubber, synthetic polyisoprene rubber, styrene-butadiene rubber (SBR), polybutadiene rubber, and mixtures thereof and wherein the at least one natural or synthetic rubbery polymer contains no butadiene-isoprene rubber but includes at least one styrene-butadiene rubber,
(ii) a silica filler and a carbon black filler,
(iii) a silica coupling agent wherein the only silica coupling agent is selected from the group consisting of organosilane polysulfides, organoalkoxymercaptosilanes, capped organoalkoxymercaptosilanes; and
mixtures thereof,
(iv) oil,
(v) diphenyl guanidine vulcanization accelerator in an amount of 1 to 3 phr, wherein no preparatory mixing step adds elemental sulfur, a thiocarbamate-based compound, a benzothiazole-based compound, a thiuram sulfide-based compound, or 4,4-dithiodimorpholine (DTDM) and the diphenyl guanidine is added in a separate preparatory mixing step after addition of (i), (ii), (iii), and (iv); and
b. subsequently blending therewith in a final mixing step a sulfur curative selected from elemental sulfur and sulfur donating compounds, wherein the average glass transition temperature of the polymer(s) is −55° C. or less.

14. The method of claim 13, wherein the silica coupling agent is an organosilane polysulfide selected from the group consisting of 3,3′-bis(trimethoxysilylpropyl)disulfide, 3,3′-bis(triethoxysilylpropyl)disulfide, 3,3′-bis(tributoxysilylpropyl)disulfide, 3,3′-bis(trihexoxysilylpropyl)disulfide, 3,3′-bis(tri-t-butoxysilylpropyl)disulfide, 3,3′-bis(dimethylmethoxysilylethyl)disulfide, 3,3′-bis(diphenylcyclohexoxysilylpropyl)disulfide, 3,3′-bis(ethyldi-secbutoxysilylpropyl)disulfide, 3,3′-bis(propyldiethoxysilylpropyl)disulfide, 12,12′-bis(triisopropyloxysilyldodecyl)disulfide, 3,3′-bis(dimethoxyphenylsilylpropyl)disulfide, and combinations thereof.

15. The method of claim 13, wherein the at least one natural or synthetic rubbery polymer further comprises polybutadiene rubber.

16. The method of claim 13, wherein the at lest one natural or synthetic rubbery polymer further comprises natural rubber.

17. The method of claim 13 wherein the silica filler is present in an amount of 30 to 100 phr.

18. The method of claim 17, wherein the carbon black filler is present in in an amount of 1 to 30 phr.

19. The method of claim 13, wherein the rubber composition includes one or more of: (vi) processing aid(s), (vii) fatty acid(s), and (viii) antidegradant(s), and (vi), (vii) and (viii) are added in a subsequent mixing stage to the preparatory mixing stage containing the diphenyl guanidine vulcanization accelerator.

20. A method of preparing a rubber composition comprising:
a. blending in at least one preparatory mixing step
(i) at least one natural or synthetic rubbery polymer selected from the group consisting of natural rubber, synthetic polyisoprene rubber, styrene-butadiene rubber (SBR), polybutadiene rubber, and mixtures thereof and wherein the at least one natural or synthetic rubbery polymer contains no butadiene-isoprene rubber but includes at least one styrene-butadiene rubber,
(ii) a silica filler and a carbon black filler,
(iii) a silica coupling agent wherein the only silica coupling agent is selected from the group consisting of organosilane polysulfides, organoalkoxymercaptosilanes, capped organoalkoxymercaptosilanes; and
mixtures thereof,
(iv) oil,
(v) diphenyl guanidine vulcanization accelerator in an amount of 1 to 3 phr, wherein no preparatory mixing step adds elemental sulfur, a thiocarbamate-based compound, a benzothiazole-based compound, a thiuram sulfide-based compound, or 4,4-dithiodimorpholine (DTDM) and the diphenyl guanidine is added in a separate preparatory mixing step after addition of (i), (ii), (iii), and (iv); and
b. subsequently blending therewith in a final mixing step a sulfur curative selected from elemental sulfur and sulfur donating compounds, wherein the average glass transition temperature of the polymer(s) is −55.2° C. to −60° C.
